(19) United States
(12) Patent Application Publication
(10) Pub. No.: US 2024/0144068 A1
(43) Pub. Date: May 2, 2024

(54) SYSTEMS AND METHODS FOR IMPROVING COMPUTATIONAL EFFICIENCY OF PROCESSOR-BASED DEVICES IN SOLVING CONSTRAINED QUADRATIC MODELS WITH PENALTY FACTORS

(71) Applicant: D-WAVE SYSTEMS INC., Burnby (CA)

(72) Inventor: Anil Mahmud, Markham (CA)

(21) Appl. No.: 18/379,799

(22) Filed: Oct. 13, 2023

Related U.S. Application Data
(60) Provisional application No. 63/420,779, filed on Oct. 31, 2022.

(51) Int. Cl. G06N 10/60

(52) U.S. Cl. CPC G06N 10/60

(57) ABSTRACT

Systems and methods for operation of a computing system to direct a search space for an optimization problem are described. One or more processors initialize an optimization algorithm, and iteratively until a termination criteria is met: receive a sample solution from the optimization algorithm, evaluate quality and feasibility of the sample solution, and where the sample solution is feasible and has the best quality so far, freeze one or more penalty parameters for a set number of iterations. Where the sample solution is not feasible or does not have the best quality so far, the one or more penalty parameters are updated based on a finite state machine, the updated one or more penalty parameters are returned to the optimization algorithm, the optimization algorithm is incremented, the termination criteria is evaluated, and when the termination criteria is met, one or more sample solutions are returned.

### FIELD

This disclosure generally relates to systems and methods for improving efficiency of processor-based devices in solving constrained quadratic models, for instance employing a hybrid approach that takes advantage of digital processors and analog processors and using penalty factors.

### BACKGROUND

### Quantum Devices

Quantum devices are structures in which quantum mechanical effects are observable. Quantum devices include circuits in which current transport is dominated by quantum mechanical effects. Such devices include spintronics and superconducting circuits. Both spin and superconductivity are quantum mechanical phenomena. Quantum devices can be used for measurement instruments, in computing machinery, and the like.

### Quantum Computation

A quantum computer is a system that makes direct use of at least one quantum-mechanical phenomenon, such as superposition, tunneling, and entanglement, to perform operations on data. The elements of a quantum computer are qubits. Quantum computers can provide speedup for certain classes of computational problems such as computational problems simulating quantum physics.

### Quantum Processor

A quantum processor may take the form of a superconducting quantum processor. A superconducting quantum processor may include a number of superconducting qubits and associated local bias devices. A superconducting quantum processor may also include coupling devices (also known as couplers or qubit couplers) that selectively provide communicative coupling between qubits.

A quantum processor is any computer processor that is designed to leverage at least one quantum mechanical phenomenon (such as superposition, entanglement, tunneling, etc.) in the processing of quantum information. Regardless of the specific hardware implementation, all quantum processors encode and manipulate quantum information in quantum mechanical objects or devices called quantum bits, or “qubits;” all quantum processors employ structures or devices for communicating information between qubits; and all quantum processors employ structures or devices for reading out a state of at least one qubit. A quantum processor may include a large number (e.g., hundreds, thousands, millions, etc.) of programmable elements, including but not limited to: qubits, couplers, readout devices, latching devices (e.g., quantum flux parametron latching circuits), shift registers, digital-to-analog converters, and/or demultiplexer trees, as well as programmable sub-components of these elements such as programmable sub-components for correcting device variations (e.g., inductance tuners, capacitance tuners, etc.), programmable sub-components for compensating unwanted signal drift, and so on.

Further details and embodiments of exemplary quantum processors that may be used in conjunction with the present systems and devices are described in, for example, U.S. Pat. Nos. 7,533,068; 8,008,942; 8,195,596; 8,190,548; and 8,421,053.

### Hybrid Computing System Comprising a Quantum Processor

A hybrid computing system can include a digital computer communicatively coupled to an analog computer. In some implementations, the analog computer is a quantum computer, and the digital computer is a classical computer.

The digital computer can include a digital processor that can be used to perform classical digital processing tasks described in the present systems and methods. The digital computer can include at least one system memory which can be used to store various sets of computer- or processor-readable instructions, application programs and/or data.

The quantum computer can include a quantum processor that includes programmable elements such as qubits, couplers, and other devices. The qubits can be read out via a readout system, and the results communicated to the digital computer. The qubits and the couplers can be controlled by a qubit control system and a coupler control system, respectively. In some implementations, the qubit and the coupler control systems can be used to implement quantum annealing on the analog computer.

### Quantum Annealing

Quantum annealing is a computational method that may be used to find a low-energy state of a system, typically preferably the ground state of the system. The method relies on the underlying principle that natural systems tend towards lower energy states, as lower energy states are more stable. Quantum annealing may use quantum effects, such as quantum tunneling, as a source of delocalization to reach an energy minimum.

A quantum processor may be designed to perform quantum annealing and/or adiabatic quantum computation. An evolution Hamiltonian can be constructed that is proportional to the sum of a first term proportional to a problem Hamiltonian and a second term proportional to a delocalization Hamiltonian, as follows:

H_{E}∝A(t)H_{P}+B(t)H_{D}
where H_{E} is the evolution Hamiltonian, H_{P} is the problem Hamiltonian, H_{D} is the delocalization Hamiltonian, and A(t), B(t) are coefficients that can control the rate of evolution, and typically lie in the range [0,1].

In some implementations, a time varying envelope function can be placed on the problem Hamiltonian. A suitable delocalization Hamiltonian is given by:

$$\\ {H}_{D} ∝ - \frac{1}{2} {\sum }_{i = 1}^{N} {Δ}_{i} {σ}_{i}^{{}^{} x}$$

where N represents the number of qubits, σᵢ^{x} is the Pauli x-matrix for the i^{th} qubit and Δᵢ is the single qubit tunnel splitting induced in the i^{th} qubit. Here, the σᵢ^{x} terms are examples of “off-diagonal” terms.

A common problem Hamiltonian includes a first component proportional to diagonal single qubit terms and a second component proportional to diagonal multi-qubit terms, and may be of the following form:

$$\\ {H}_{P} ∝ - \frac{ε}{2} [ {\sum }_{i = 1}^{N} {h}_{i} {σ}_{i}^{{}^{} z} + {\sum }_{j > i}^{N} {J}_{ij} {σ}_{i}^{{}^{} z} {σ}_{j}^{{}^{} z} ]$$

where N represents the number of qubits, σᵢ^{z} is the Pauli z-matrix for the i^{th} qubit, hᵢ and Jᵢⱼ are dimensionless local fields for the qubits, and couplings between qubits, and E is some characteristic energy scale for Hr.

Here, the σᵢ^{z} and σᵢ^{z} σⱼ^{z} terms are examples of “diagonal” terms. The former is a single qubit term and the latter a two-qubit term.

Throughout this specification, the terms “problem Hamiltonian” and “final Hamiltonian” are used interchangeably unless the context dictates otherwise. Certain states of the quantum processor are energetically preferred, or simply preferred, by the problem Hamiltonian. These include the ground states and may include excited states.

Hamiltonians such as H_{D} and H_{P} in the above two equations may be physically realized in a variety of different ways. A particular example is realized by an implementation of superconducting qubits.

### Sampling

In statistics, a sample is a subset of a population, i.e., a selection of data taken from a statistical population. In electrical engineering and related disciplines, sampling relates to taking a set of measurements of an analog signal or some other physical system.

In many fields, including simulations of physical systems, and computing, especially analog computing, the foregoing meanings may merge. For example, a hybrid computer can draw samples from an analog computer. The analog computer, as a provider of samples, is an example of a sample generator. The analog computer can be operated to provide samples from a selected probability distribution, the probability distribution assigning a respective probability of being sampled to each data point in the population. The population can correspond to all possible states of the processor, and each sample can correspond to a respective state of the processor.

As discussed in further detail below, a hybrid computing system may return sample solutions, for example by operating an analog computer to provide samples from a distribution.

The foregoing examples of the related art and limitations related thereto are intended to be illustrative and not exclusive. Other limitations of the related art will become apparent to those of skill in the art upon a reading of the specification and a study of the drawings.

### BRIEF SUMMARY

According to an aspect, there is provided a method of operation of a computing system to direct a search space towards feasibility to improve performance of the computing system, the computing system comprising one or more processors, the method being performed by at least one of the one or more processors, the method comprising: receiving a problem definition comprising a set of variables, an objective function defined over the set of variables, and one or more constraint functions, each of the constraint functions defined by at least one variable of the set of variables, initializing an optimization algorithm, a sample solution to the objective function, and one or more penalty parameters corresponding to each of the constraint functions, iteratively until a termination criteria is met: incrementing the optimization algorithm, for each variable in the set of variables: sampling an updated value for the variable, evaluating a feasibility result of each constraint function defined by the variable, updating a problem feasibility result, the problem feasibility result comprising the feasibility result of each of the constraint functions, and for each constraint function defined by the variable where the constraint function was not feasible, increasing the penalty parameter by a first rate, after updating each variable in the set of variables, evaluating the problem feasibility result, when the problem feasibility result indicates feasibility was encountered for all constraint functions, decreasing all penalty parameters by a second rate, storing each updated penalty parameter, evaluating the termination criteria, and when the termination criteria is met, outputting a solution comprising an updated set of variables.

According to other aspects, incrementing the optimization algorithm may comprise incrementing one of simulated annealing, parallel tempering, and quantum annealing, increasing the penalty parameter by a first rate may comprise increasing the penalty parameter by a first rate that depends on the termination criteria and a number of variables that participate in the respective constraint function, decreasing all penalty parameters by a second rate may comprise decreasing all penalty parameters by a second rate that depends on the termination criteria, evaluating the termination criteria may comprise evaluating a number of iterations, outputting a solution comprising the updated set of variables may comprise outputting a solution comprising a plurality of updated sets of variables, and the method may further comprise transmitting pairs of the sample solutions to a quantum processor, instructing the quantum processor to refine the pairs of the sample solutions, and returning refined sample solutions, and instructing the quantum processor to refine the pairs of the sample solutions may comprise instructing the quantum processor to perform quantum annealing to select a variable value for each variable from between respective variable values provided by the pairs of the sample solutions.

According to an aspect, there is provided a system to direct a search space for an optimization problem towards feasibility to improve performance of a computing system, the system comprising: at least one non-transitory processor-readable medium that stores at least one of processor executable instructions and data, and at least one processor communicatively coupled to the least one non-transitory processor-readable medium, which, in response to execution of the at least one of processor executable instructions and data, the processor: receives a problem definition comprising a set of variables, an objective function defined over the set of variables, and one or more constraint functions, each of the constraint functions defined by at least one variable of the set of variables, initializes an optimization algorithm, a sample solution to the objective function, and one or more penalty parameters corresponding to each of the constraint functions, iteratively until a termination criteria is met: increments the optimization algorithm, for each variable in the set of variables: samples an updated value for the variable, evaluates a feasibility result of each constraint function defined by the variable, updates a problem feasibility result, the problem feasibility result comprising the feasibility result of each of the constraint functions, and for each constraint function defined by the variable where the constraint function was not feasible, increases the penalty parameter by a first rate, after updating each variable in the set of variables, evaluates the problem feasibility result, when the problem feasibility result indicates feasibility was encountered for all constraint functions, decreases all penalty parameters by a second rate, stores each updated penalty parameter, evaluates the termination criteria, and when the termination criteria is met, outputs a solution comprising an updated set of variables.

According to other aspects, the optimization algorithm may comprise one of simulated annealing, parallel tempering, and quantum annealing, the first rate may depend on the termination criteria and a number of variables that participate in the respective constraint function, the second rate may depend on the termination criteria, the termination criteria may comprise a number of iterations, the system may further comprise a quantum processor, and wherein in response to execution of the at least one of processor executable instructions and data, the processor may output a solution comprising a plurality of updated sets of variables, and further: transmit pairs of the sample solutions to the quantum processor, instruct the quantum processor to refine the pairs of the sample solutions, and return refined sample solutions, and the processor may instruct the quantum processor to perform quantum annealing to select a variable value for each variable from between respective variable values provided by the pairs of the sample solutions.

According to an aspect, there is provided a method of operation of a computing system to direct a search space for an optimization problem towards feasibility to improve performance of the computing system, the computing system comprising one or more processors, the method being performed by at least one of the one or more processors, the method comprising: initializing an optimization algorithm, iteratively until a termination criteria is met: receiving a sample solution from the optimization algorithm, evaluating quality and feasibility of the sample solution, where the sample solution from the optimization is feasible and has a best quality so far, freezing one or more penalty parameters for a set number of iterations, where the sample solution is not feasible or does not have the best quality so far, updating the one or more penalty parameters based on a finite state machine, returning the updated one or more penalty parameters to the optimization algorithm, incrementing the optimization algorithm, and evaluating the termination criteria, and in response to the termination criteria being met, returning one or more sample solutions.

According to other aspects, updating the one or more penalty parameters based on a finite state machine may comprise entering one of a growing state, an exploring state, and a frozen state and acting on the one or more penalty parameters based on the entered one of the growing state, the exploring state, or the frozen state, entering a growing state and acting on the one or more penalty parameters based on the growing state may comprise increasing the one or more penalty parameters, entering an exploring state and acting on the one or more penalty parameters based on the exploring state may comprise performing a search for new values for the one or more penalty parameters, and entering a frozen state and acting on the one or more penalty parameters based on the frozen state may comprise maintaining current values for the one or more penalty parameters, entering a growing state and acting on the one or more penalty parameters based on the growing state by increasing the one or more penalty parameters may comprise increasing the one or more penalty parameters based on a growth function, increasing the one or more penalty parameters based on a growth function may comprise increasing the one or more penalty parameters based on a growth function that depends on the number of iterations performed, performing a search for new values for the one or more penalty parameters may comprise performing a stochastic binary search, initializing an optimization algorithm may comprise initializing an objective function, one or more constraints, and one or more initial values for the one or more penalty parameters, initializing an optimization algorithm may comprise initializing one of simulated annealing, parallel tempering, and quantum annealing, returning one or more sample solutions may comprise: transmitting pairs of sample solutions to a quantum processor, instructing the quantum processor to refine the pairs of samples, and returning refined sample solutions, and instructing the quantum processor to refine the pairs of sample solutions may comprise instructing the quantum processor to perform quantum annealing to select a variable value for each variable from between respective variable values provided by the pairs of sample solutions.

According to an aspect there is provided a system to direct a search space for an optimization problem towards feasibility to improve performance of the computing system, the system comprising: at least one non-transitory processor-readable medium that stores at least one of processor executable instructions and data, and at least one processor communicatively coupled to the least one non-transitory processor-readable medium, which, in response to execution of the at least one of processor executable instructions and data performs any of the methods described herein.

According to an aspect there is provided a method of operation of a computing system to direct a search space for an optimization problem towards feasibility to improve performance of the computing system, the computing system comprising one or more processors, the method being performed by at least one of the one or more processors, the method comprising: initializing an optimization algorithm, initializing the optimization including initializing one or more penalty parameters and setting a current state of the one or more penalty parameters to a growing state, iteratively until a termination criteria is met: receiving a sample solution from the optimization algorithm, evaluating quality and feasibility of the sample solution, where the sample solution from the optimization is feasible and has a best quality so far, freezing the one or more penalty parameters at the current state for a set number of iterations, where the sample solution is not feasible or does not have the best quality so far, updating the one or more penalty parameters, updating the one or more penalty parameters comprising: identifying the current state of the one or more penalty parameters as one of growing, exploring, and frozen, where the current state is growing, evaluating the feasibility of the sample solution, where the sample solution is feasible, changing the current state of the one or more penalty parameters to exploring, where the sample solution is not feasible, increasing the one or more penalty parameters based on a growth function and ending the updating, where the current state of the one or more penalty parameters is exploring, evaluating an exploring threshold, where the exploring threshold is achieved, changing the current state of the one or more penalty parameters to frozen, where the exploring threshold is not achieved, performing a search to generate a new value for the one or more penalty parameters and ending the updating, where the current state is frozen, evaluating a freeze threshold, where the freeze threshold is achieved, changing the current state to growing, where the freeze threshold is not achieved, maintaining the one or more penalty parameters and ending the updating, returning the updated one or more penalty parameters to the optimization algorithm, incrementing the optimization algorithm, and evaluating the termination criteria, and in response to the termination criteria being met, returning one or more sample solutions to the optimization problem.

According to other aspects, increasing the one or more penalty parameters based on a growth function may comprise increasing the one or more penalty parameters based on a growth function that depends on the number of iterations performed, performing a search to generate a new value for the one or more penalty parameters may comprise performing a stochastic binary search, initializing an optimization algorithm may comprise initializing one of simulated annealing, parallel tempering, and quantum annealing, returning one or more sample solutions to the optimization problem may comprise: transmitting pairs of the sample solutions to a quantum processor, instructing the quantum processor to refine the pairs of sample solutions, and returning refined sample solutions, and instructing the quantum processor to refine the pairs of sample solutions may comprise instructing the quantum processor to perform quantum annealing to select a variable value for each variable from between respective variable values provided by the pairs of sample solutions.

According to an aspect, there is provided a system for directing a search space for an optimization problem towards feasibility to improve performance of the computing system, the system comprising at least one non-transitory processor-readable medium that stores at least one of processor executable instructions and data, and at least one processor communicatively coupled to the least one non-transitory processor-readable medium, which, in response to execution of the at least one of processor executable instructions and data performs any of the methods described herein.

In other aspects, the features described above may be combined together in any reasonable combination as will be recognized by those skilled in the art.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of a hybrid computing system including a digital computer coupled to an analog computer, in accordance with the present systems, devices, and methods.

FIG. 2 is a schematic diagram of a portion of an exemplary superconducting quantum processor.

FIG. 3 is flow diagram of an example method of operation of a computing system to direct a search space.

FIG. 4 is a flow diagram of an example method of operation of a hybrid computing system.

FIG. 5 is flow diagram of an example alternative method of operation of a computing system to direct a search space.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

As an illustrative example, a superconducting quantum processor designed to perform adiabatic quantum computation and/or quantum annealing is used in the description that follows. However, as previously described, a person of skill in the art will appreciate that the present systems and methods may be applied to any form of quantum processor hardware (e.g., superconducting, photonic, ion-trap, quantum dot, topological, etc.) implementing any form of quantum algorithm(s) (e.g., adiabatic quantum computation, quantum annealing, gate/circuit-based quantum computing, etc.). A quantum processor may be used in combination with one or more classical or digital processors. Methods described herein may be performed by a classical or digital processor in communication with a quantum processor that implements a quantum algorithm. Further, in some implementations, the methods described herein may be performed entirely by a classical or digital processor.

### Exemplary Computing System

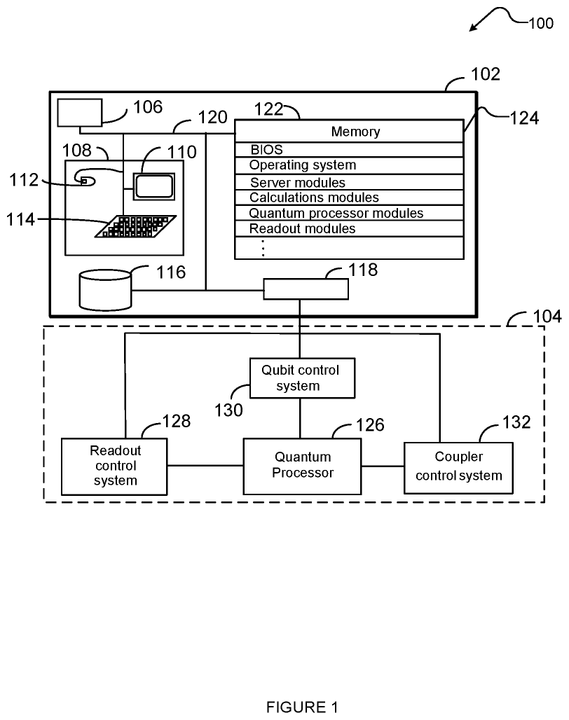

FIG. 1 illustrates a hybrid computing system 100 comprising a digital computer 102. The example digital computer 102 includes one or more digital processors 106 that may be used to perform classical digital processing tasks. Digital computer 102 may further include at least one system memory 122, and at least one system bus 120 that couples various system components, including system memory 122 to digital processor(s) 106. System memory 122 may store one or more sets of processor-executable instructions, which may be referred to as modules 124.

The digital processor(s) 106 may be any logic processing unit or circuitry (for example, integrated circuits), such as one or more central processing units (“CPUs”), graphics processing units (“GPUs”), digital signal processors (“DSPs”), application-specific integrated circuits (“ASICs”), programmable gate arrays (“FPGAs”), programmable logic controllers (“PLCs”), etc., and/or combinations of the same.

In some implementations, hybrid computing system 100 comprises an analog computer 104, which may include one or more quantum processors 126. Quantum processor 126 may include at least one superconducting integrated circuit. Digital computer 102 may communicate with analog computer 104 via, for instance, a controller 118. Certain computations may be performed by analog computer 104 at the instruction of digital computer 102, as described in greater detail herein.

Digital computer 102 may include a user input/output subsystem 108. In some implementations, the user input/output subsystem includes one or more user input/output components such as a display 110, mouse 112, and/or keyboard 114.

System bus 120 may employ any known bus structures or architectures, including a memory bus with a memory controller, a peripheral bus, and a local bus. System memory 122 may include non-volatile memory, such as read-only memory (“ROM”), static random-access memory (“SRAM”), Flash NAND; and volatile memory such as random-access memory (“RAM”) (not shown).

Digital computer 102 may also include other non-transitory computer- or processor-readable storage media or non-volatile memory 116. Non-volatile memory 116 may take a variety of forms, including: a hard disk drive for reading from and writing to a hard disk (for example, a magnetic disk), an optical disk drive for reading from and writing to removable optical disks, and/or a solid-state drive (SSD) for reading from and writing to solid state media (for example NAND-based Flash memory). Non-volatile memory 116 may communicate with digital processor(s) via system bus 120 and may include appropriate interfaces or controllers 118 coupled to system bus 120. Non-volatile memory 116 may serve as long-term storage for processor- or computer-readable instructions, data structures, or other data (sometimes called program modules or modules 124) for digital computer 102.

Although digital computer 102 has been described as employing hard disks, optical disks and/or solid-state storage media, those skilled in the relevant art will appreciate that other types of nontransitory and non-volatile computer-readable media may be employed. Those skilled in the relevant art will appreciate that some computer architectures employ nontransitory volatile memory and nontransitory non-volatile memory. For example, data in volatile memory may be cached to non-volatile memory. Or a solid-state disk that employs integrated circuits to provide non-volatile memory.

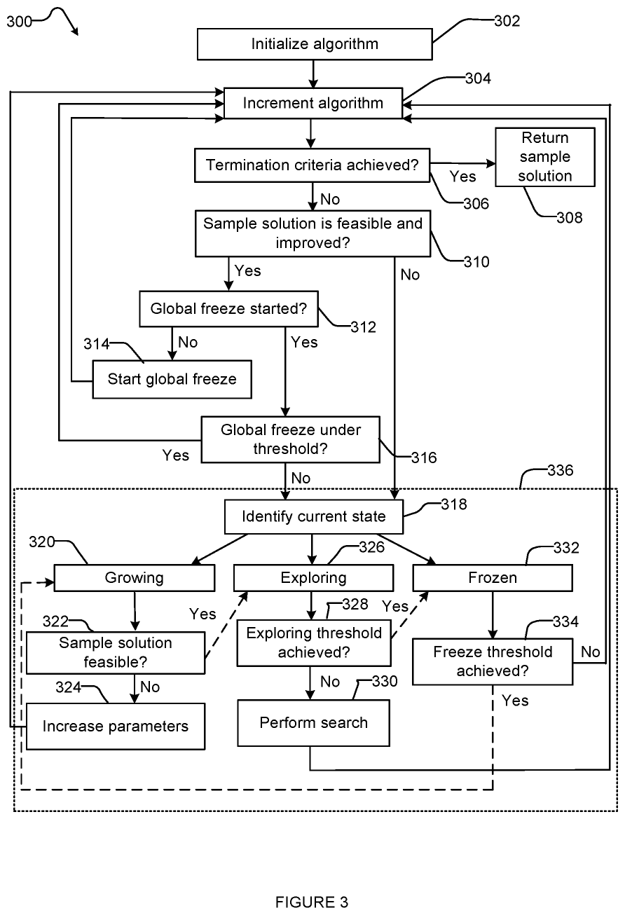

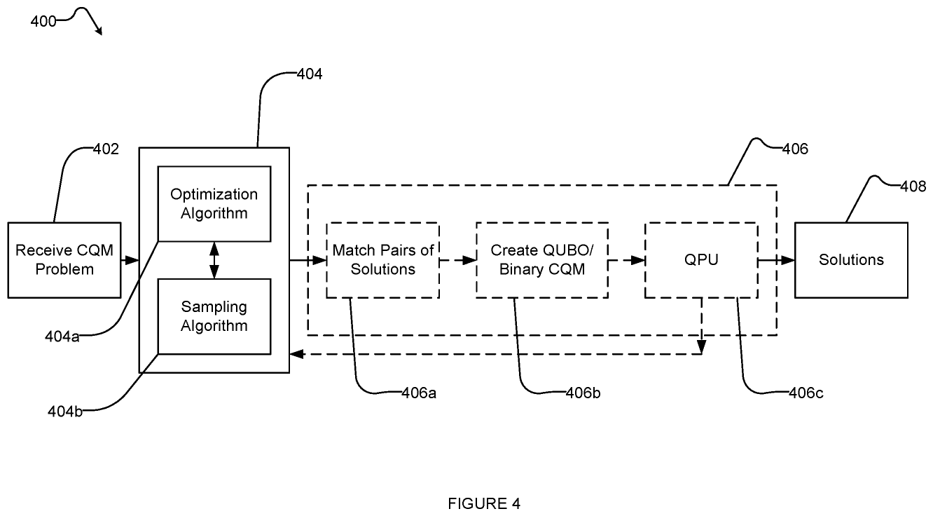

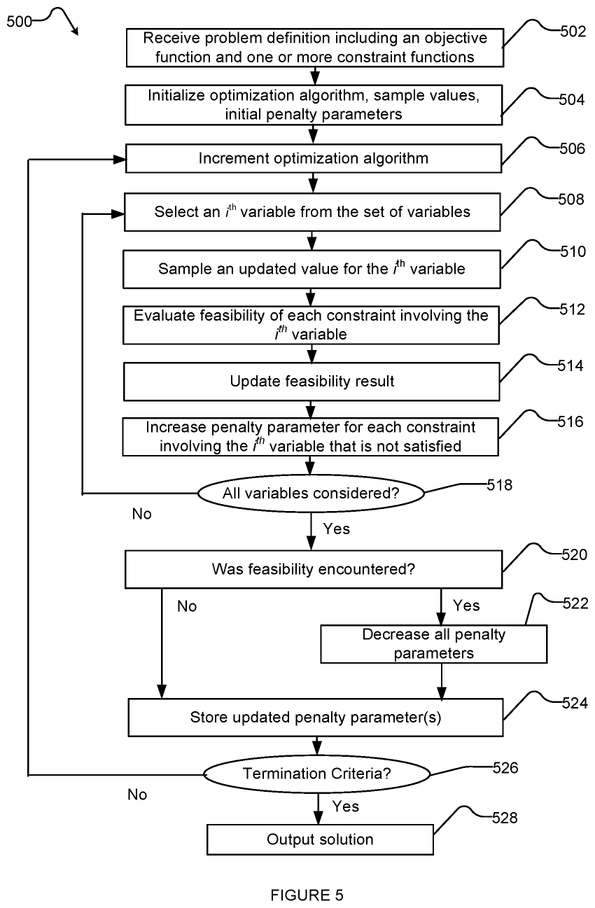

Various processor- or computer-readable and/or executable instructions, data structures, or other data may be stored in system memory 122. For example, system memory 122 may store instructions for communicating with remote clients and scheduling use of resources including resources on the digital computer 102 and analog computer 104. Also, for example, system memory 122 may store at least one of processor executable instructions or data that, when executed by at least one processor, causes the at least one processor to execute the various algorithms to execute instructions. In some implementations system memory 122 may store processor- or computer-readable calculation instructions and/or data to perform pre-processing, co-processing, and post-processing to analog computer 104. System memory 122 may store a set of analog computer interface instructions to interact with analog computer 104. For example, the system memory 122 may store processor- or computer-readable instructions, data structures, or other data which, when executed by a processor or computer causes the processor(s) or computer(s) to execute one, more or all of the acts of the method 300 (FIG. 3), method 400 (FIG. 4), and/or method 500 (FIG. 5).

Analog computer 104 may include at least one analog processor such as quantum processor 126. Analog computer 104 may be provided in an isolated environment, for example, in an isolated environment that shields the internal elements of the quantum computer from heat, magnetic field, and other external noise. The isolated environment may include a refrigerator, for instance a dilution refrigerator, operable to cryogenically cool the analog processor, for example to temperature below approximately 1 K.

Analog computer 104 may include programmable elements such as qubits, couplers, and other devices (also referred to herein as controllable devices). Qubits may be read out via readout system 128. Readout results may be sent to other computer- or processor-readable instructions of digital computer 102. Qubits may be controlled via a qubit control system 130. Qubit control system 130 may include on-chip Digital to Analog Converters (DACs) and analog lines that are operable to apply a bias to a target device. Couplers that couple qubits may be controlled via a coupler control system 132. Coupler control system 132 may include tuning elements such as on-chip DACs and analog lines. Qubit control system 130 and coupler control system 132 may be used to implement a quantum annealing schedule as described herein on analog processor (e.g., quantum processor 126). Programmable elements may be included in quantum processor 126 in the form of an integrated circuit. Qubits and couplers may be positioned in layers of the integrated circuit that comprise a first material. Other devices, such as readout control system 128, may be positioned in other layers of the integrated circuit that comprise a second material. In accordance with the present disclosure, a quantum processor, such as quantum processor 126, may be designed to perform quantum annealing and/or adiabatic quantum computation. Examples of quantum processors are described in U.S. Pat. No. 7,533,068.

### Exemplary Superconducting Quantum Processor

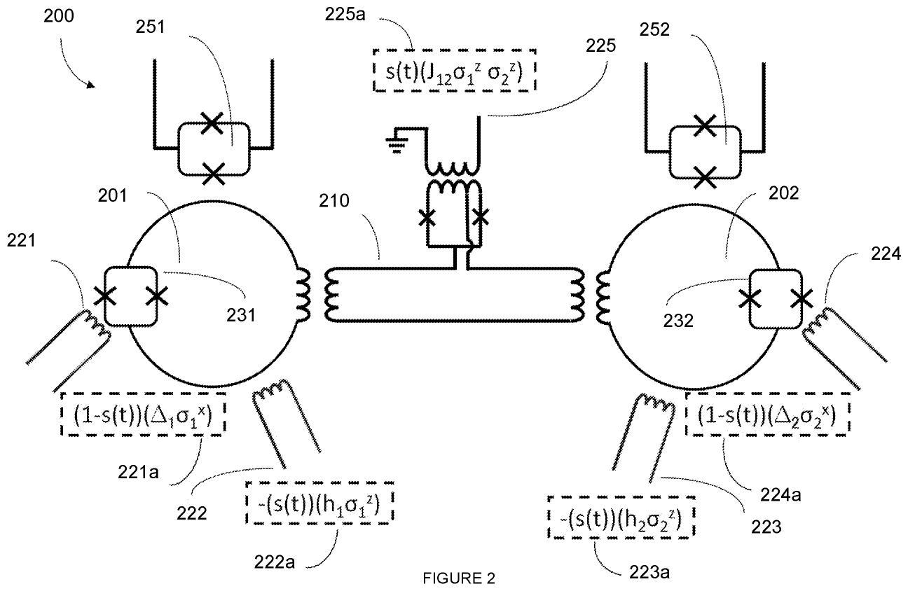

FIG. 2 is a schematic diagram of a portion of an exemplary superconducting quantum processor 200, according to at least one implementation. Superconducting quantum processor 200 may be implemented within hybrid computing system 100 of FIG. 1, forming all or part of quantum processor 126. The portion of superconducting quantum processor 200 shown in FIG. 2 includes two superconducting qubits 201, and 202. Also shown is a tunable coupling (diagonal coupling) via coupler 210 between qubits 201 and 202 (i.e., providing 2-local interaction). While the portion of quantum processor 200 shown in FIG. 2 includes only two qubits 201, 202 and one coupler 210, those of skill in the art will appreciate that quantum processor 200 may include any number of qubits and any number of couplers coupling information between them.

Quantum processor 200 includes a plurality of interfaces 221, 222, 223, 224, 225 that are used to configure and control the state of quantum processor 200. Each of interfaces 221-225 may be realized by a respective inductive coupling structure, as illustrated, as part of a programming subsystem and/or an evolution subsystem. Alternatively, or in addition, interfaces 221-225 may be realized by a galvanic coupling structure. In some implementations, one or more of interfaces 221-225 may be driven by one or more DACs. Such a programming subsystem and/or evolution subsystem may be separate from quantum processor 200, or may be included locally (i.e., on-chip with quantum processor 200).

In the operation of quantum processor 200, interfaces 221 and 224 may each be used to couple a flux signal into a respective compound Josephson junction 231 and 232 of qubits 201 and 202, thereby realizing a tunable tunneling term (the Δᵢ term) in the system Hamiltonian. This coupling provides the off-diagonal 6× terms of the Hamiltonian and these flux signals are examples of “delocalization signals”. Examples of Hamiltonians (and their terms) used in quantum computing are described in greater detail in, for example, U.S. Patent Application Publication No. 2014/0344322.

Similarly, interfaces 222 and 223 may each be used to apply a flux signal into a respective qubit loop of qubits 201 and 202, thereby realizing the hᵢ terms (dimensionless local fields for the qubits) in the system Hamiltonian. This coupling provides the diagonal σ^{z} terms in the system Hamiltonian. Furthermore, interface 225 may be used to couple a flux signal into coupler 210, thereby realizing the Jᵢⱼ term(s) (dimensionless local fields for the couplers) in the system Hamiltonian. This coupling provides the diagonal σᵢ^{z}σⱼ^{z} terms in the system Hamiltonian.

In FIG. 2, the contribution of each of interfaces 221-225 to the system Hamiltonian is indicated in boxes 221a-225a, respectively. As shown, in the example of FIG. 2, the boxes 221a, 222a, 223a, 224a, 225a are elements of time-varying Hamiltonians for quantum annealing and/or adiabatic quantum computing.

While FIG. 2 illustrates only two physical qubits 201, 202, one coupler 210, and two readout devices 251, 252, a quantum processor (e.g., processor 200) may employ any number of qubits, couplers, and/or readout devices, including a larger number (e.g., hundreds, thousands or more) of qubits, couplers and/or readout devices. Examples of superconducting qubits include superconducting flux qubits, superconducting charge qubits, and the like. In a superconducting flux qubit, the Josephson energy dominates or is equal to the charging energy. In a charge qubit this is reversed. Examples of flux qubits that may be used include radio frequency superconducting quantum interference devices, which include a superconducting loop interrupted by one Josephson junction, persistent current qubits, which include a superconducting loop interrupted by three Josephson junctions, and the like.

### Constrained Quadratic Problems

Quadratic functions refer to polynomial functions with one or more variables that have at most second-degree interactions. Many real-world problems can be expressed as a combination of a quadratic function to be optimized and a number of constraints placed on the feasible outcomes for the variables. In other words, a quadratic function (also referred to herein as an objective function) defines interactions between the variables, subject to a constraint or set of constraints. In order to obtain optimal or near-optimal solutions (i.e., optimized solutions) to a given problem, the objective function can be minimized or maximized, subject to the constraints on feasible results. As used herein, “feasible” refers to solutions where all of the constraints are satisfied, or in other words, where none of the constraint functions are violated. This can be referred to as a constrained quadratic model (CQM) problem. In the example implementations described below, the problems are structured such that minimization, or lower energies, correspond with improved solutions (i.e., solutions of better or higher quality relative to other solutions), given that the constraints on the problem are satisfied, that is, the outcomes for the variables provide feasible solutions. However, it will be understood that minimization problems may alternatively be structured as maximization problems (for example by reversing the sign of the function), and that the principles below apply generally to situations where an objective function is extremized. That is, while minimization is discussed for clarity below, it will be understood that similar principles could be applied to functions that are maximized, and the term “minimized” could be substituted with “extremized”, and the energy penalties described below would be applied to penalize directions away from improved solutions.

In an example implementation, a CQM is defined by:

$$\\ minimize {\sum }_{i} {a}_{i} {x}_{i} + {\sum }_{i , j} {b}_{i , j} {x}_{i} {x}_{j} subject to$$

$$\\ {\sum }_{i} {a}_{i , m}^{{}^{} ′} + {\sum }_{i , j} {b}_{i , j , m}^{{}^{} ′} + {c}_{m} \leq 0 ∀ m ∈ M$$

where xᵢ are the problem variables (which may be binary, discrete, integer, continuous, etc.) and M is set of constraints. aᵢ is the linear bias for variable i and b_{i,j} are quadratic biases between variables i and j in the objective function. Similarly, a′_{i,m} b′_{i,j,m} are linear and quadratic biases for constraint m.

As used herein, a “sample solution” refers to a set of values for the problem variables of the objective function. An optimization algorithm will typically return a series of sample solutions throughout the performance of the optimization. The “quality” of a sample solution is determined by the energy of the objective function evaluated at those variable values. Typically, during performance of an optimization algorithm, the quality of the sample solutions will improve. The “feasibility” of a sample solution is determined by evaluation of the constraint functions evaluated at those variable values. “Satisfying” constraints, that is, evaluating a constraint function at those variable values and finding that it is feasible, may involve modifying the performance of an optimization algorithm.

In order to allow some flexibility in solving, which may beneficially increase the probability of finding a global optimum, while also ensuring that constraints are satisfied by a final solution (that is, the sample solution that is returned at the end of the optimization algorithm), a penalty value may be assigned to the constraints, allowing the weight that the constraints are given to be varied, such that the constraint may be violated in some circumstances (such as at the start of an optimization or sampling algorithm). When adding constraints to an objective function, a penalty value for the constraint may need to be selected without any guidance as to an appropriate penalty value in the given problem. This may result in the need to solve the problem multiple times with different penalty values to find better final solutions (i.e., better quality final solutions). The presently described systems and methods allow for selecting a penalty value without solving the problem multiple times with different penalty values, and for dynamic adjustment of the penalty value during the solving process, thereby advantageously improving computational efficiency of the computer system.

In general, during simulated annealing, at sweep or iteration k, it is beneficial to update the variables to minimize (or alternatively maximize) the original objective function with the violation of the constraints as added penalty terms multiplied by the penalty parameters:

$$\\ minimize {f}^{{}^{} ′} = {\sum }_{i} {a}_{i} {x}_{i} + {\sum }_{i , j} {b}_{i , j} {x}_{i} {x}_{j} + {\sum }_{m} {{μ}_{m}^{{}^{} k} ( {v}_{m}^{{}^{} k} )}^{2}$$

where vₘ^{k} is the violation in constraints in iteration k of the annealing and μₘ^{k} is the penalty parameter for constraint m. With relatively high values of μₘ^{k}, the annealer will likely satisfy the corresponding constraints to the detriment of finding the lowest energy sample solutions as the objective will have less weight in the annealing. Conversely, with relatively small values of μₘ^{k}, the sample solutions may not be feasible. That is, selecting overly high values for μₘ^{k} may satisfy constraints prematurely and result in a less optimal final solution to the objective function, while overly low values may result in sample solutions being produced that violate one or more constraints, also known as infeasible sample solutions. The penalty parameters (also referred to as Lagrange multipliers) have values for penalties assigned to each constraint, which are adjusted iteratively throughout the optimization process in order to direct the search spaces toward feasibility. When a variable update returns a non-feasible sample solution as described above, it may be beneficial to increase the penalty value. When a variable update returns a feasible sample solution, the penalty may be relaxed to increase the likelihood that an optimal sample solution can be found.

As discussed above, in the context of a constrained model, there is a tension between obtaining the lowest energy sample solution for the objective function and ensuring that all of the constraints are satisfied. Weighting the constraints too little can result in low energy sample solutions (e.g., better or higher quality sample solutions) that are not feasible, while weighting the constraints too much can result in feasible sample solutions that are far from optimal (e.g., poorer or lower quality sample solutions). It can be beneficial to allow the weights given to the constraints to grow through the optimization algorithm, increasing the probability that a near optimal sample solution to the objective function is found, and that the constraints are also satisfied. It may also be beneficial to select an intermediate initial value, such that the penalty parameters may grow or shrink throughout the optimization algorithm, or to start from a large value that directs the search space towards feasibility. In some implementations, the penalty parameters may be initialized according to a heuristic. This may provide values for the penalty parameters that may be larger than optimal, and given that an optimization algorithm such as simulated annealing starts at a high temperature, the penalty parameters may grow slightly to reach feasibility and then decrease to reach more optimal sample solutions. It may, however, be beneficial to moderate the selection of initial penalty parameters to avoid extremely large penalty parameters for the sake of achieving feasibility. Instead, it may be beneficial to tune the parameters such that feasibility can be achieved while allowing for sufficient exploration that the algorithm will not get stuck in a local optimum, and instead find a final solution that is close to the global optimum. Thus, it is beneficial to continuously adjust the penalty parameters based on whether the corresponding constraints are satisfied, that is, if the sample solutions are feasible or not. It may also be beneficial to adjust the penalty parameters in such a way that the evolution of penalty parameters is similar for different time budgets (implying higher number of sweeps) to provide better results from longer runtimes. Here by similar it is meant that ideally with two different annealing budgets the penalty parameters should have similar values at equivalent portions of elapsed annealing budget. For example, the penalty for a constraint with a shorter annealing time at the middle of the annealing should be similar to the penalty of the same constraint at the middle of annealing when the annealing budget is longer. This implies that annealing with a longer budget is a finer version of the annealing with a shorter budget with a high probability, which increases the probability of getting better sample solutions from a longer annealing budget. Thus, it may be beneficial to apply penalty parameters that maintain monotonicity, that is, longer annealing times should produce better results than shorter annealing times with a high probability. Results that degrade with increased annealing times can occur where monotonicity is not maintained, and as a result, optimal or close to optimal final solutions may not be provided. Maintaining monotonicity may beneficially provide improved results when solving CQM problems.

FIG. 3 is a flow diagram of an example method 300 of operation of a computing system to direct a search space for an optimization problem towards feasibility to improve performance of the computing system as executed on a computing system comprising one or more processors. Method 300 may be executed on a hybrid computing system comprising at least one digital or classical processor and a quantum processor, for example hybrid computing system 100 of FIG. 1, or by a classical computing system comprising at least one digital or classical processor. In some implementations of a quantum processor as part of the hybrid computing system, superconducting quantum processor 200 of FIG. 2 may form all or a part of the quantum processor.

Method 300 comprises even numbered acts 302 to 334; however, a person skilled in the art will understand that the number of acts illustrated is an example, and, in some implementations, certain acts may be omitted, further acts may be added, and/or the order of the acts may be changed. Method 300 is performed by at least one of the one or more processors. In some implementations, method 300 may be performed by digital computer 102 of FIG. 1, and may be in communication with quantum processor 126.

Method 300 starts at 302, for example in response to a call or invocation from another routine.

At 302, the processor initializes an optimization algorithm. Initializing the optimization algorithm can include initializing one or more penalty parameters and setting a current state of the one or more penalty parameters to a growing state. As discussed above, the one or more penalty parameters may be initialized according to a heuristic algorithm, and may, for example, be set to an approximate midpoint, a low value, or a high value in different implementations.

At 304, the processor increments an optimization algorithm such as a simulated annealing algorithm, a parallel tempering algorithm, or a quantum annealing algorithm. Incrementing the algorithm can, for example, include sampling a new set of values for the variables of the problem based on the previous values for the variables of the problem. An increment can also be referred to as a “sweep”, where all of the variable values are updated to produce a sample solution. In some implementations the new sample solutions may be generated from a pair of sample solutions generated at a previous iteration or iterations, with new variable values selected between the two options provided by the pair of sample solutions. In some implementations this generation of new sample solutions may be performed by a quantum computer.

At 306, a termination criteria is evaluated. For example, a termination criteria could include an amount of time during which sweeps, or iterations are performed or a predetermined number of sweeps or iterations. Where the termination criteria is satisfied, method 300 proceeds to 308, where one or more sample solutions (i.e., final solutions) to the optimization problem are returned. Typically, these sample solutions will be the best result (i.e., having the best or highest quality) seen so far by the algorithm. For example, this may be a lowest energy sample solution encountered or a set of low energy sample solutions depending on the application. That is, at each iteration the sample solutions found by method 300 may be stored, and more than one of the sample solutions encountered may be returned at act 308.

Where the termination criteria is not satisfied, the current sample solution is received from the optimization algorithm and control passes to act 310. It will be understood that during a complete implementation of method 300 both of acts 308 and 310 will occur at least once. In some implementations, the sample solutions may then be passed to other algorithms or methods. As discussed in further detail below with respect to FIG. 4, in some implementations, at act 308, pairs of sample solutions are transmitted to a quantum processor, the quantum processor is instructed to refine the pairs of sample solutions, and refined sample solutions are returned. In some implementations quantum processor can perform quantum annealing to select variable values between the options provided by the two sample solutions.

At 310, the sample solution is evaluated with respect to quality and feasibility. Where the sample solution from the optimization is feasible and is evaluated as having the best or highest quality so far, control passes to act 312. At 312, the current state or status of a global freeze is evaluated (e.g., is global freeze started). If the global freeze has not been started, then the control passes to 314, where the one or more penalty parameters are frozen at the current state for a set number of iterations, where set number of iterations may for example be specified by a predetermined number of iterations or a predetermined amount of time in which iterations are performed. This is also referred to at act 314 as starting a global freeze. The term “global freeze” is used to distinguish from the update freeze described below with respect to act 332. It will be understood that during this global freeze the values of the penalty parameters will remain the same (i.e., be frozen), and the state of the penalty parameters will be “stored” such that the state of the penalty parameters will return to whatever it was prior to beginning the global freeze. When the global freeze is started at act 314, control passes back to act 304. On successive iterations, where the global freeze has already been started, the current state or status of the global freeze is evaluated at act 312 and control is passed to act 316. At 316, the current global freeze is evaluated relative to a global freeze threshold. Where the current global freeze is under the global freeze threshold, control passes to act 304. The global freeze threshold may be a number of increments of the optimization algorithm, also referred to as a number of “sweeps”, and/or an amount of time. Where the current global freeze has reached the global freeze threshold, control passes to act 318 as discussed below. A global freeze of the penalty parameters can beneficially allow for the optimization algorithm to explore the feasible space and potentially find improved sample solutions. When a feasible sample solution is found that is better (e.g., lower energy) than any of the previously encountered feasible sample solutions, the penalty parameters for all constraints are maintained at the same value for a set number of sweeps (the global freeze threshold) or an amount of time based on the idea that the current set of penalty parameters is likely a good set of penalty parameters.

Where at 310 the sample solution is not feasible or does not have the best quality so far, control passes to an update portion of the algorithm and the one or more penalty parameters are updated according to the update portion. It will be understood that in this context “update” includes cases where the values of the penalty parameters stay the same for one or more iterations, such as where they are frozen. This begins with act 318, where the current state of the penalty parameters is identified. In this example implementation, the current state can be labeled as one of “growing”, “exploring”, and “frozen”. During a first iteration of method 300, the current state of the penalty parameters may be growing. For example, in some implementations during act 302, the current state of the penalty parameters may be initialized as growing.

In some implementations, acts 318 through 334 may be considered a finite state machine 336, and the one or more penalty parameters may be updated based on finite state machine 336. As noted above, updating the penalty parameters as described herein includes cases where the values are “updated” to be the same value when the state is “frozen”. In some implementations, a finite state machine used in method 300 may have only the “growing” and “exploring” states. At the start of method 300, all of the penalty parameters may be started in the growing state. After a global freeze, the current state will be the state that the penalty parameters were in immediately prior to the global freeze starting, that is, they will return to their previous state.

At 320, the current state is identified as the growing state. At act 322, the processor evaluates if the current sample solution is feasible, that is, if all of the constraints are satisfied. Where the sample solution is feasible the current state of the one or more penalty parameters is changed to exploring, and control passes to act 326. Where the sample solution is not feasible, the one or more penalty parameters are increased at 324 based on a growth function and the update portion of the algorithm is ended. The growth function can, in some implementations, depend on the number of iterations performed. Control then passes back to act 304 and the algorithm increments based on the new penalty parameters.

In an example implementation of method 300, the penalty parameters begin in the growing state and can continue to grow until the constraint functions are satisfied such that the sample solution is feasible. Once the sample solutions begin to be feasible (that is, all of the constraints are satisfied), the state for all of the penalty parameters may change to exploring. In an example implementation, the growth rate for the penalty parameters may be given by:

$$\\ growth\_rate = {e}^{{}^{} ( growth \_ constant / total \_ num \_ sweeps )} Or g = {e}^{\frac{c}{{n}_{t}}}$$

Where nₜ is the total number of sweeps, and c is a constant. The value of the constant c may be tuned for a particular implementation. Thus, where the algorithm is failing to provide feasible sample solutions, the penalty parameter of a constraint, denoted as Lᵢ at iteration i, will grow according to a sequence such as:

Lᵢ,Lᵢg,Lᵢg²,Lᵢg³, . . .

Thus, where the total number of sweeps to be performed by the method is a small value, the growth rate will be faster, while a total number of sweeps that is higher gives a slower growth rate, resulting in the penalty parameter value that would be reached by growing alone being the same for different total numbers of sweeps or iterations. That is, assuming the penalty of a constraint is initialized to L₀, and n sweeps pass without finding a feasible sample solution and the penalty parameter only grows, then at the end of n sweeps the penalty parameter will be given by:

Lₙ=L₀gⁿ

Where n is the current sweep number, L₀ the initial penalty parameter, and Lₙ is the penalty parameter after the current sweep number. L₀ will typically be initialized at the start of the algorithm, for example at act 302 of FIG. 3.

In some implementations, the exponential growth of penalty parameters can beneficially achieve feasibility in a consistent manner. By providing a growth rate that is dependent on the total number of sweeps, monotonicity is maintained, ensuring that as the number of sweeps is increased, the penalty parameter would reach the same final value if feasibility is not reached. That is, if the penalty parameter values continue to grow throughout the algorithm, they would reach the same value at the end of the algorithm regardless of the number of sweeps or iterations performed. It will be understood that in the discussion above, an amount of time may be substituted for a number of sweeps for some implementations.

In some implementations, it may be beneficial to increase the penalty parameter using an extra term whose power grows with the number of iterations or sweeps that pass after the sample solutions have become infeasible. Denoting this new parameter as k, the growth of the penalty terms can be described by the equations below:

$$\\ g = {e}^{\frac{c}{{n}_{t}}}$$

$$\\ k = \frac{{c}^{{}^{} ′}}{{e}^{{}^{} {n}_{t} ( {n}_{t} - 1 )}}$$

For a particular growing iteration, the penalty parameter is multiplied every sweep by g, as well as by increasing powers of k. That is the penalty parameters grow according to:

Lᵢ,Lᵢg,Lᵢggk,Lᵢgggkk²,Lᵢggggkk²k³

That is:
Lᵢ, Lᵢg, Lᵢg²k, Lᵢg³k³, Lᵢg⁴k⁶ Where the penalty parameter at a given growing step may be given by:

Lᵢ₊ₙ_{_{f}}=Lᵢgⁿ^{_{f}}kⁿ^{_{f}}

Where Lₛₜ is the penalty parameter at the start of the growth stage and n_{f} is the number of failures (that is, iterations without feasible sample solutions) that have occurred since the growth stage began. It will be understood that the formula above is an example of how this term may be included, and in some implementations, it may be beneficial to introduce a lag to the application of the extra term k, that is, growing the penalty using only the term g, and after a pre-determined number of sweeps, introducing the additional k growth term. Assuming a lag of 2, the above equation will be modified to:

$$\\ {L}_{i + {n}_{f}} = {L}_{i} {g}^{{n}_{f}} {k}^{max ( 0 , ( {n}_{f} - 2 ) \frac{( nf - 2 - 1 )}{2} )}$$

In some implementations the penalty for a constraint may also grow based on the ratio of the violation of the respective constraint with the sum of the violations of all the constraints. The growth rate, g applied to a particular constraint may be raised to the power of a value which is derived from the ratio of the violation of the individual constraint with the sum of the violation of all the constraints. For example:

$$\\ {b}_{l} = \frac{{v}_{l}}{{\sum }_{1}^{j} {v}_{i}}$$

Where vᵢ is the magnitude of the violation of the constraint associated with penalty parameter l, and Σ₁^{j}vᵢ is the sum of all violations of all constraints. The growth rate g as discussed above may be modified by a scaling factor based on the ratio given by bₗ. In one implementation, g may be raised to the power of a value that is calculated by raising bₗ to the power of the inverse of a constant may be referred to as the shrinking power. Thus, if at sweep i, the sample solution is infeasible, at sweep i+1, the penalty parameter can be given as:

$$\\ {L}_{i + 1} = {L}_{i} {g}^{{b}^{\frac{1}{shrinking power}}}$$

In general, the shrinking power may be in the range of 4 to 8, and powers of 2, like 4 or 8, may be chosen for easier computation. In some implementations the calculation of bₗ may use a scaled form of the violations, for example,

$$\\ {v}_{{l}_{c}} = \frac{{v}_{l}}{max ( maximum abs bias , abs offset )} ,$$

where max(maximum abs bias, abs offset) is the maximum selected from among the absolute values of the biases in the particular constraint function and the absolute value of the offset in the particular constraint function.

This provides that in the growing state each penalty parameter will receive some change or growth at each iteration, guided by the violation of the constraint in comparison to the violation of the other constraints. It can be beneficial to select an intermediate value for the shrinking power, and can be beneficial to tune this shrinking power for a given implementation. Smaller shrinking powers may allow for feasibility to be reached faster in some cases, but may also cause the growth rate to vary wildly, which may decrease annealing quality for some problems, while larger shrinking powers will reduce the effect of the guidance. When the ratio of the violation of a constraint to the sum of all of the violations is used, it may be beneficial to calculate the growth rate according to:

$$\\ {g}_{m} = {g}_{base}^{{}^{} {( \frac{scaled violation}{total scaled violation} )}^{\frac{1}{{s}_{p}}}} Where {g}_{base} = {e}^{( \frac{c}{n} {( \frac{num \_ constraints}{α} )}^{\frac{1}{{s}_{p}}} )}$$

And sₚ is the shrinking power as discussed above and α is a constant selected to limit the growth rate. num_contraints is an integer value giving the number of constraints in the problem. Considering the number of constraints in calculating the growth rate using the above equation allows the growth rate to be scaled to compensate for the violation ratio such that the growth rate is not unduly decreased or increased. This is based on the assumption that b^{1/s}^{ₚ} has, on average, a magnitude of the order of

$$\\ {( \frac{1}{num\_constraints} )}^{\frac{1}{{s}_{p}}} .$$

At 326, the current state is identified as the exploring state. At act 328, an exploring value is evaluated relative to an exploring threshold. This may, for example, be a count of a number of times that exploring has been performed consecutively. Where the exploring threshold has been achieved, control passes to act 332 where the current state of the one or more penalty parameters is changed to frozen. Where the exploring threshold is not achieved, control passes to act 330. At 330, a search is performed to generate a new value for the one or more penalty parameters and the update portion of the algorithm is ended. In some implementations the search may be a stochastic binary search. Control then passes back to act 304 and the algorithm increments based on the new penalty parameters.

Once the penalty parameters have grown until the sample solutions are feasible, the neighborhood of the penalty parameters is explored, with the intent of finding new lower penalty values which would give a feasible sample solution with lower or improved energy. In some implementations, a searching method such as a stochastic binary search may be used. Stochastic binary searching is discussed in further detail below. It will be understood that other types of searches or explorative methods may also be used, for example, the penalty parameters can be decreased linearly. Binary searching refers generally to a search method for a sorted array. Provided a lower bound and an upper bound, an element in the middle is compared with the target value, and half of the array can be eliminated based on the result. This process continues, eliminating the half of the array in which the target value cannot lie, until the target value is located.

A stochastic binary search follows a similar search pattern to find optimal values of penalty parameters. The exploration may allow for the values of the penalty parameters to be decreased from the penalty parameters that provided the initial feasible sample solution, increasing the likelihood of finding sample solutions with a lower energy. In other words, it may be beneficial to search for a lower value of the penalty parameter in the same neighborhood as the current penalty parameters that induced a feasible sample solution that will also provide feasible sample solutions in order to attempt to improve sample solution quality or obtain lower energy sample solutions. During each iteration of growth, the penalty parameters grow by an amount each sweep. Once exploring begins, a search is performed between an upper and lower range determined based on the value of the penalty parameter where the sample solution became feasible and the growth rate. For example, in some implementations, the range may be determined by taking the lower bound of the range as the last value where a returned sample solution was not feasible and the upper bound of the range as the current value where the sample solution is feasible, for each penalty parameter.

In an implementation where constraint m is infeasible during sweep k with a penalty parameter μₘ^{k} and, during growing, the value of the penalty parameter is increased to μₘ^{k+1} and it becomes feasible, the optimal, or improved, penalty parameter value is expected to lie between μₘ^{k} and μₘ^{k+1}. That is, the range for the search is given by: [μₘ^{k}, μₘ^{k+1}]. In this implementation, the search will have μ^{k+1} as the upper bound and μ^{k} as the lower bound. A midpoint value is selected for the penalty parameter, and a new sample solution is taken with that penalty parameter at act 304. If the constraint is satisfied with a new sample solution found with the new midpoint penalty parameter, then a new search is performed between the lower bound and the midpoint penalty parameter, that is for the next sweep the midpoint acts as the new upper bound. In the case where the constraint continues to be satisfied, this process of focusing the search range to lower values continues until the constraint is not satisfied or the exploring threshold is achieved. Conversely, if the constraint is not satisfied by a given sample solution, the search is performed between the midpoint and the upper bound. That is for the next sweep the midpoint will act as the new lower bound. In the case where the constraint continues to not be satisfied, this process of focusing the search range to higher values continues until the constraint is satisfied or the exploring threshold is achieved. In most implementations the constraint will vary between being satisfied and not being satisfied, and the range will be focused above and below the selected midpoint accordingly. This process for searching optimal penalty parameters, such that the penalty parameters allow for feasible sample solutions but are also as low as possible given the temperature continues until exploring threshold is achieved. When the exploring threshold is achieved, the penalty parameter is set to the most recent value that provided a feasible sample solution. Overall, the returned penalty parameter will decrease from the initial penalty parameter at the start of the exploring, however, at each stage of exploring the returned value may increase or decrease based on the feasibility of the sample solution with the previously returned penalty parameter.

This method is referred to as a stochastic binary search as it uses the principles of binary search, but instead of an array of sorted elements to search, a continuous range of penalty parameters is provided. As used herein, the term “stochastic” is intended to refer to the randomness introduced by the nature of the optimization algorithm. For example, where simulated annealing is used, noise is introduced based on temperature, which may be simulated by generating random numbers. In quantum annealing, there is both noise introduced by the environment and inherent randomness due to the quantum nature of the evolution. At each iteration of the optimization algorithm, the choice of variables will be probabilistic due to the temperature, which will determine if the sample solution as a whole is feasible or infeasible, that is, the search is probabilistic rather than deterministic. As the search at the exploring state is not among discrete elements, the exact optimal value for the penalty parameter is unlikely to be achieved, and instead the search is likely to provide a value close to the optimal value. This value is likely to give feasible sample solutions with a high probability and also have a relatively low magnitude given the current temperature, allowing for more optimal sample solutions to be found. The state is then changed to frozen, allowing for sample solutions to be taken with the same penalty parameters for a number of iterations or an amount of time. The new set of penalty parameters may be closer to an optimal set of penalty parameters after the exploring is completed, and the optimization algorithm may beneficially be allowed to explore this neighborhood for a set number of iterations determined by a predetermined number of iterations or a predetermined amount of time to return improved sample solutions.

In an example implementation, considering the penalty parameter for a single constraint, a penalty parameter of 6 for the particular constraint function results in a sample solution that is an infeasible sample solution, and in the next iteration a penalty parameter of 9, generated by growing the penalty parameter value, results in a sample solution that is a feasible sample solution. The state is changed to exploring, and the lower bound of the search range is set to 6, with the upper bound set to 9, and the expectation that an optimal penalty parameter lies somewhere in the range 6 to 9. The penalty parameter for the next iteration is selected by stochastic binary search as 7.5. In this example, using a penalty parameter of 7.5 in the constraint function returns a sample solution that is an infeasible sample solution, and it can be determined that the optimal penalty parameter is now in the range of 7.5 to 9. The next search will return a penalty parameter of 8.25. Assuming that this penalty parameter results in a sample solution that is a feasible sample solution, the optimal penalty parameter is now likely to lie in the range of 7.5 to 8.25. At the next iteration a penalty parameter of 7.88 is returned. Assuming that this returns a sample solution that is an infeasible sample solution, and that for this example implementation that the number of iterations for exploring is set to three, the value for this penalty parameter will be set to 8.25 at the end of the exploring and the state will be changed to frozen for a number of iterations.

In some implementations, the search range for the penalty parameter may have a lower bound given by the minimum value between μₘ^{k} and μₘ^{k}/(growth_rate^{constant_cut_down_power}). In some implementations, the value of constant_cut_down_power can be in the range of 2 to 4. In particular, raising growth_rate to the power of constant_cut_down_power increases the exploration of infeasible sample solutions. In other implementations the lower bound may be selected based on a percentage, for example, 10% or 20% less than the upper bound value. That is, the upper bound may be provided as the last penalty parameter that provided a feasible sample solution, and the value of that penalty parameter may be reduced by a given percentage. It is noted that as the value of each penalty parameter may be different, it is likely that for each penalty parameter the size of the search range will be different.

In some implementations, the penalty parameters may have a scaled decrease during the exploring state in a similar manner to the growth of the penalty parameters in the growing state described above. That is, there may be a base decrease rate that is scaled proportionally to the distance from binding for each constraint, where the binding value is the value at which both sides of an inequality or equality constraint are equal. In alternative implementations, the lower bound may be determined based on the distance from binding for each constraint.

While it is beneficial for the sample solutions returned to be feasible, particularly at later stages of the optimization, it can also be beneficial to allow the sample solutions to become infeasible at early or mid-stages of the optimization. Allowing the penalty parameters to be relaxed to sample solutions that are infeasible may allow for the optimization algorithm to explore different sample solutions as well as different distributions of penalty parameters. For some problems, a rugged landscape of potential solutions, that is, a potential solution landscape having many local maxima and minima can have different distributions of penalty parameters that provide sample solutions that are feasible. It may be beneficial to explore different distributions of penalty parameters to increase the likelihood of finding improved sample solutions.

At 332, the current state is identified as the frozen state. At act 334, a freeze threshold is evaluated. This may, for example, be a count of a number of times that the current state has been identified as frozen consecutively. Where the freeze threshold has been achieved, the current state of the one or more penalty parameters is changed to growing, and control is passed to act 320. Where the freeze threshold is not achieved, the current values for the one or more penalty parameters are maintained, and the update portion of the algorithm is ended. Control then passes back to act 304 and the algorithm increments based on the same penalty parameters as in the previous iteration.

In some implementations, it can be beneficial not to change penalty parameters in every sweep. In optimization algorithms such as simulated annealing, improved (or lower energy) sample solutions may be found with each iteration. Therefore, by allowing the simulated annealing to explore the solution landscape with a particular set of penalty parameters can be beneficial. This may also be referred to as allowing the annealer to “get used to” the new set of penalty parameters, or to thermalize the annealer. Therefore, once a presumably improved set of penalty parameters has been found by the exploring state, it can be beneficial to maintain those penalty parameters for a set number of sweeps or a set amount of time. After the freeze threshold has been achieved (which may be a total number of sweeps, and/or a set number of consecutive sweeps where the sample solutions have been found to be infeasible, or an amount of time) the penalty parameters are again updated by growing and exploring.

Method 300 returns sample solutions at 308 and then terminates until it is, for example, invoked again. Method 300 may be performed by a system for directing a search space for an optimization problem towards feasibility to improve performance of the computing system, the system comprising at least one non-transitory processor-readable medium that stores at least one of processor executable instructions and data and at least one processor communicatively coupled to the least one non-transitory processor-readable medium, which, in response to execution of the at least one of processor executable instructions and data performs method 300. In some implementations, method 300 may be performed by hybrid computing system 100 described above with reference to FIG. 1.

In some implementations, method 300 may be performed over all penalty parameters as a set. That is, all penalty parameters will be in the same current state, e.g., growing throughout method 300. This may beneficially increase the rate of convergence to feasibility, as modifications to penalty parameters will work in a synchronized manner. However, in other implementations, method 300 may be performed such that the current state of each penalty parameter may vary between constraints. For example, some of the penalty parameters may be growing, while others may be exploring. As above, in some implementations it may be beneficial to maintain all penalty parameters in the same state, as feasibility may be reached more easily or more often. In particular, growing all penalty parameters when some constraints have been violated can beneficially allow the method to reach feasibility for problems where feasibility is difficult to reach. As discussed in detail above, in some cases the growth rate of the penalty parameters may be weighted such that penalty parameters associated with constraints that are not violated may not grow at all for those constraints, may not grow substantially, or may grow only a small amount, while penalty parameters associated with constraints that are violated will grow more substantially.

In some implementations, only some of the penalty parameters may be penalized as discussed herein. A first set of penalty parameters may be adjusted according to the systems and methods described herein, while a second set of penalty parameters may be weighted differently. For example, in some implementations, an optimization problem may have some constraints that are considered necessary to achieve feasible sample solutions, while other constraints may provide more preferable sample solutions but are not considered necessary for a sample solution to be feasible. For example, in a manufacturing context, a constraint may define that each machine may only perform one task at a time, and as it is physically not possible for a machine to perform two separate tasks simultaneously, this is a “hard”, or necessary constraint. A separate constraint may define that all manufacturing tasks be performed during an 8-hour shift. As it may be possible to schedule a different employee or provide overtime, this may be considered a “soft”, or preferable constraint, but not necessary for a feasible sample solution. The set of penalty parameters associated with “hard” constraints may be adjusted according to the methods described herein, while the set of penalty parameters associated with “soft” constraints may be set to a preset value, or a value given by a user for a particular problem. Further, in some implementations, while “hard” constraints may be addressed using the methods described herein, “soft” constraints may be considered by the algorithm when incrementing the objective function. For example, a “soft” constraint may be addressed as a penalty parameter multiplied by a value for the magnitude of the violation of the “soft” constraint that is added to the objective function, and therefore optimized alongside the objective function. In other implementations, a subset of the penalty parameters may be determined as described herein, while other penalty parameters are set by other methods, for example, the methods described in International Application No. PCT/IB2022/000201.

In some implementations, it may be beneficial to apply more than one algorithm to determine penalty parameters for a given problem. For example, it may be beneficial to apply the algorithm described herein to a portion of the sample solutions returned by an optimization algorithm (i.e., final solutions), while applying a different algorithm to the remaining portion of the sample solutions to be returned by an optimization algorithm. For example, given 100 sample solutions to be returned by an optimization algorithm, 50 of those sample solutions may be returned according to the method described with respect to FIG. 3. The other 50 sample solutions may be returned according to the method described in International Application No. PCT/IB2022/000201. This may be beneficial as the selection of penalty parameters is complex and for some cases different selection methods may return improved results. While a lower energy sample solution may in some cases be returned by taking 100 sample solutions (i.e., 100 final solutions) with a single method, in many cases low energy sample solutions will be found by each method, and by using two or more methods the sample solutions returned may have lower energies for a greater breadth of optimization problems.

FIG. 4 is a flow diagram of an example method 400 of operation of a hybrid computing system for finding a sample solution to an optimization problem or other problem that may be expressed as a constrained quadratic model. Method 400 may be executed on a hybrid computing system comprising at least one digital or classical processor and a quantum processor, for example hybrid computing system 100 of FIG. 1.

Method 400 comprises even numbered acts 402 to 408; however, a person skilled in the art will understand that the number of acts illustrated is an example, and, in some implementations, certain acts may be omitted, further acts may be added, and/or the order of the acts may be changed.

Method 400 starts, for example, in response to a call from another routine.

At 402, the processor (e.g., digital processor 106 of FIG. 1) receives a constrained quadratic model (CQM) problem (also referred to herein as a constrained quadratic optimization problem), the constrained quadratic optimization problem having a set of variables, an objective function defined over the set of variables, one or more constraint functions, each of the constraint functions defined by at least one variable of the set of variables, and a progress parameter for the optimization, the progress parameter comprising a set of values incrementing between an initial value and a final value.

At 404, the processor generates sample solutions for the CQM problem using optimization algorithm 404a and sampling algorithm 404b. In some implementations, act 404 may include iteratively, until the final value of a progress parameter is reached: sampling a sample solution comprising a set of values for the set of variables of an optimization algorithm, updating the sample solution with an update algorithm by, for each variable of the set of variables: determining an objective energy change based on the sampled value for the variable and one or more terms of the objective function that include the variable, determining a constraint energy change based on the sampled value for the variable and each of the constraint functions defined by the variable, determining a total energy change based on the objective energy change and the constraint energy change, determining a variable type for the variable, selecting a sampling distribution based on the variable type, and sampling an updated value for the variable from the sampling distribution based on the total energy change and the progress parameter, and then returning an updated sample solution, the updated sample solution comprising the updated value for each variable of the set of variables and incrementing the progress parameter. Method 300 described above or method 500 described below may form part of sampling algorithm 404b, or may be incorporated as part of optimization algorithm 404a.

At 406, a quantum processor (e.g., quantum processor 126 of FIG. 1), optionally refines the sample solutions, for example in response to instructions from the digital processor and receipt of the one or more sample solutions generated after reaching the final value of the progress parameter, or another termination criteria. In some implementations, the one or more sample solutions may be transmitted to the quantum processor as pairs of sample solutions that may be matched (at 406a), and the quantum processor may refine the pairs of sample solutions by performing quantum annealing to select between variable values in the sample solutions (at 406b and 406c).

At 408, the processor outputs sample solutions to the CQM problem. In some implementations, these sample solutions may be returned to a user (e.g., via an output device). In other implementations, the sample solutions may be passed to another algorithm for refinement, or may be returned to act 404 as a sample set of values as an input to the optimization algorithm. The method 400 can then terminate, unless it is iterated, or until it is, for example, invoked again.

See International Application No. PCT/IB2022/000201 for a further discussion of solving constrained quadratic models (CQMs).

FIG. 5 is a flow diagram of an example alternative method of operation of a computing system to direct a search space towards feasibility to improve performance of the computing system.

Method 500 may be executed on a hybrid computing system comprising at least one digital or classical processor and a quantum processor, for example hybrid computing system 100 of FIG. 1, or by a classical computing system comprising at least one digital or classical processor. In some implementations of a quantum processor as part of the hybrid computing system, superconducting quantum processor 200 of FIG. 2 may form all or a part of the quantum processor.

Method 500 comprises even numbered acts 502 to 528; however, a person skilled in the art will understand that the number of acts illustrated is an example, and, in some implementations, certain acts may be omitted, further acts may be added, and/or the order of the acts may be changed. Method 500 is performed by at least one of the one or more processors. In some implementations, method 500 may be performed by digital processor 106 of FIG. 1, and may be in communication with quantum processor 126.

Method 500 starts at 502, for example in response to a call or invocation from another routine.

At 502, the processor receives a problem definition comprising a set of variables, an objective function defined over the set of variables, and one or more constraint functions, each of the constraint functions defined by at least one variable of the set of variables.

At 504, the processor initializes an optimization algorithm, a sample solution to the objective function, and one or more penalty parameters corresponding to each of the constraint functions. In some implementations the optimization algorithm may be one of a simulated annealing algorithm, a parallel tempering algorithm, or a quantum annealing algorithm.

In some implementations the one or more penalty parameters may be initialized according to a heuristic algorithm, and may, for example, be set to an approximate midpoint, a low value, or a high value in different implementations. In some implementations the sample solution may be initialized based on input from a user, may be generated by another algorithm and provided to the processor, or may be a predetermined initial sample solution stored in memory and called by the processor.

At 506, the processor increments the optimization algorithm. Incrementing the algorithm can, for example, update a progress parameter such as a temperature in a simulated annealing algorithm or increment an iteration or “sweep” count. The iteration through acts 506 through 526 can be referred to as a “sweep”, where all of the variable values are updated to produce a sample solution. In some implementations incrementing the algorithm may also, for example, include sampling a new set of values for the variables of the problem based on the previous values for the variables of the problem. In some implementations the new sample solutions may be generated from a pair of sample solutions generated at a previous iteration or iterations, with new variable values selected between the two options provided by the pair of sample solutions. In some implementations this generation of new sample solutions may be performed by a quantum computer. In some implementations these selected values may be used as a starting point for sampling new values in the acts of 508 through 516. In other implementations, act 506 may occur concurrently with or may encompass acts 508 and 510, that is, act 506 may provide updated values for the variables as act 510 which are evaluated as outlined in acts 508 through 518.

At 508, the processor selects an i^{th} variable from the set of variables.

At 510, the processor samples an updated value for the i^{th} variable. It will be understood that in some implementations sampling an updated value for the i^{th} variable can include sampling the same value for the i^{th} variable as the current value. For example, where the i^{th} variable is binary, and the current value is 0, the i^{th} variable may have an updated sample value of 0 or 1.

At 512, the processor evaluates feasibility of each constraint involving the i^{th} variable. That is, the feasibility of each constraint function defined by the variable is evaluated with the values of all of the other variables at their current value. Where the constraint is satisfied when evaluated at the updated value of the i^{th} variable, that constraint is feasible.

At 514, the processor updates the problem feasibility result for the sweep. Problem feasibility refers to the solution being feasible for all of the constraints in the problem, thereby providing a feasible solution to the problem. In some implementations, a count of how many constraints are unsatisfied is maintained. In some implementations the feasibility results for each variable update are stored. In other implementations only a value indicating if feasibility was encountered during each act in the sweep is stored. For example, the value may be the smallest number of unsatisfied constraints encountered during the sweep, and when this value reaches zero, this will indicate that problem feasibility was encountered during the sweep. In other implementations an indicator may be stored that indicates if feasibility was encountered during the sweep. For example, a binary variable may be stored, and the first time problem feasibility is encountered during the sweep, the binary variable may be flipped. Alternatively, when feasibility is encountered during the sweep, a feasibility indicator may be set to “TRUE”. Constraints that do not involve the i^{th} variable maintain the same feasibility, while the constraints that do involve the i^{th} variable are updated to reflect the current feasibility. If the only unsatisfied constraints from a previous iteration are satisfied based on the updated value of the i^{th} variable, the count of how many constraints are unsatisfied may be set to zero. It will be understood that in implementations where the problem has both hard constraints and soft constraints, the count of how many constraints are unsatisfied may only include the hard constraints. In the discussion below, it will be understood that feasibility may be encountered when all hard constraints are satisfied, even when one or more soft constraints remains violated or unsatisfied. In other words, soft constraints may not be considered when evaluating problem feasibility. It will be understood that additional variable updates later in the sweep may cause constraints to later become unsatisfied and the count may return above zero within the loop from act 508 to act 518, and in this case, feasibility will still be considered to have been achieved for the sweep. In some implementations, where a feasible solution is found during the variable updates, that is, during the iterations of acts 508 through 518, the energy of the feasible solution is evaluated and compared to the current best solution. Where the solution is better, that is, the energy is lower, the solution is saved as the best solution. In some implementations a set of best solutions may be saved, for example, the five or ten best solutions encountered so far in the method. It will be understood that any number of best solutions may be stored. In one example implementation, if a feasible solution is encountered after updating the 10^{th} variable, and that solution is the best solution so far, that solution would be saved. If a feasible solution is again encountered after updating the 20^{th} variable having an improved (lower) energy, the best solution can be updated by updating only those variables between the 10^{th} variable and the 20^{th} variable to their updated values. This may beneficially reduce the number of memory operations required to store the best solution as each variable in the set of variables does not need to be overwritten, which may beneficially reduce the computational complexity of maintaining the best solution encountered so far.

At 516, the processor increases the penalty parameter for each constraint that involves the i^{th} variable, where that constraint was not feasible, by a first rate. For example, if the i^{th} variable participates in three constraint functions, and two of those constraint functions were satisfied at the updated value for the i^{th} variable and the third constraint function was not satisfied, then only the penalty parameter for the third constraint function will be increased. In some implementations, it may be beneficial to provide an exponential growth rate as discussed above with respect to FIG. 3. It may also be beneficial to provide an exponential growth rate that depends both on the termination criteria and the number of variables in the particular constraint. For example, where the termination criteria is a number of sweeps performed through the optimization algorithm, such as a number of iterations through acts 506 through 526, the growth rate may be dependent on the number of sweeps. A growth rate dependent on the number of sweeps performed or other termination criteria preserves monotonicity as discussed above. As each variable has the potential to update the penalty parameter of each constraint it participates in, a growth rate dependent on the number of variables in the constraint can moderate the growth of that penalty parameter relative to those of the other constraints. As an example, in some implementations, the growth rate may be set according to the formula:

$$\\ growth\_rate \_of \_constraint \_i = {e}^{{}^{} ( growth \_ constant / ( num \_ sweeps * num \_ variables \_ in \_ constraint \_i ) )} )$$

$$\\ Or {g}_{i} = {e}^{\frac{{g}_{{c}_{}}}{{n}_{s} {n}_{i}}}$$

This formula may beneficially provide a penalty parameter for each constraint that, if method 500 was performed multiple times with different numbers of sweeps, the penalty parameters started at the same values each run, and the penalty parameters were to grow throughout method 500, regardless of the number of sweeps performed, they would reach the same value. That is, the penalty parameters would grow by the same factor regardless of the number of sweeps. Further, if all the constraint functions are not satisfied during an entire sweep, the penalty parameter of each constraint function will grow by the same factor regardless of the number of variables in the different constraint functions. During the iterations through acts 508 to 518, the penalty parameters can be increased as each variable is considered if feasibility is not found.

At 518, the processor evaluates if all of the variables have been considered. When one or more variables has not been considered, control passes back to act 508. When all of the variables have been considered, control passes to act 520.

At 520, after each variable in the set of variables has been updated, the processor evaluates the updated feasibility result to determine if problem feasibility was encountered during the sweep. For example, where the number of unsatisfied constraints is stored, the processor checks to see if zero unsatisfied constraints was achieved at any point in the updates of acts 508 through 518. In another example, where an indicator is stored, the processor calls the indicator to determine if problem feasibility was encountered at any point during the sweep.

At 522, in the case when problem feasibility was encountered for all constraint functions at some point during the update, the processor decreases all penalty parameters by a second rate. In implementations where a count of unsatisfied constraints is maintained, if the count was at zero at any stage during the variable updates, feasibility has been encountered. In some implementations, the penalty parameters may all be reduced by a rate dependent on the termination criteria. For example, where the termination criteria is a number of sweeps performed through the optimization algorithm, that is, a number of iterations through acts 506 through 526, the decrease rate may be dependent on the number of sweeps. For example, the decrease may be dependent on the maximum growth rate for a particular sweep. As an example, in some implementations, the maximum growth rate for a given constraint in a sweep may be given by:

$$\\ max\_growth \_rate \_per \_sweep = {e}^{{}^{} ( growth \_ constant / ( num \_ sweeps ) )}$$

$$\\ Or {g}_{max} = {e}^{\frac{{g}_{{c}_{}}}{{n}_{s}}}$$

And the decrease rate d may therefore be given by:

$$\\ d = {( {e}^{\frac{{g}_{{c}_{}}}{{n}_{s}}} )}^{k}$$

Where k is an exponent that may be determined experimentally for a given problem or problem class, or may be a predetermined value or defined by a user. In some implementations, k may be an integer value, such as 1 or 2, or may be a decimal value such as 0.9 or 2.1. It will be understood that these values are examples only, and other values may be used. In some implementations, the penalty parameters may be decreased by a rate that is either the maximum factor or the square of the maximum factor by which a penalty parameter would be able to grow during an entire sweep. That is, during a sweep a constraint can grow by a maximum growth rate, and if feasibility is encountered during that sweep the penalty parameters are divided by that maximum growth rate raised to an exponent. Unlike the growth of the penalty parameters, which can occur with each variable update, the decrease of the penalty parameters can happen once per sweep after the variable updates are completed, if feasibility is encountered during that sweep.

At 524, the processor stores any penalty parameters that were updated for use in the next sweep. Optionally, at act 524, the processor may also store the updated set of variables as a sample solution. As discussed above with respect to act 514, where a feasible sample is found during the variable update iterations of acts 508 through 518, the processor may evaluate the energy of the feasible solution when it is encountered, and compare this energy to the currently stored best feasible solution. If the energy is lower, that is, the solution is an improvement over the currently stored best feasible solution, then the processor may update the stored best feasible solution with the feasible sample. It will be understood that in this implementation, the act of storing the updated set of variables of act 524 may partially or entirely occur as part of act 514. In other implementations, all of the sample solutions may be stored, and all or a portion of the sample solutions may be returned at act 528. In some implementations, the set of variable values making up any feasible solutions encountered during the sweep may be stored, as well as the set of variable values at the end of the sweep. The set of variable values at the end of the sweep can be used as the starting point for the next sweep.

At 526, the processor evaluates the termination criteria. For example, a termination criteria could include an amount of time during which sweeps, or iterations are performed or a predetermined number of sweeps or iterations. If the termination criteria has not been met, control passes back to act 506 and the processor increments the optimization algorithm. If the termination criteria has been met, control passes to act 528. It will be understood that during a complete implementation of method 500 both of acts 506 and 528 will occur at least once.

At 528, the processor outputs a solution in the form of an updated set of variables. As discussed above, the updated set of variables may be the best feasible solution encountered during acts 506 through 526. In other implementations all feasible updated sets of variables may be returned as sample solutions, or a number of the best feasible solutions may be returned as a set of good solutions. For example, this may be a lowest energy sample solution encountered or a set of low energy sample solutions depending on the application. That is, at each iteration the sample solutions found by method 500 may be stored, and more than one of the sample solutions encountered may be returned at act 528. Additionally, in some implementations, the solution can also include the variable values from the final sweep, that is, the updated variable values when the termination criteria is achieved, regardless of the feasibility of these solutions. For example, in some implementations, the output solution can include the ten best feasible solutions and the ten most recent sets of updated variable values from the ten final sweeps. In some implementations, the sample solutions may then be passed to other algorithms or methods. As discussed with respect to FIG. 4, in some implementations, at act 528, pairs of sample solutions are transmitted to a quantum processor, the quantum processor is instructed to refine the pairs of sample solutions, and refined sample solutions are returned. In some implementations quantum processor can perform quantum annealing to select variable values between the options provided by the two sample solutions.

After act 528, method 500 terminates until it is invoked again. In some implementations method 500 may be iterated, or control may pass to another method.

The above described method(s), process(es), or technique(s) could be implemented by a series of processor readable instructions stored on one or more nontransitory processor-readable media. Some examples of the above described method(s), process(es), or technique(s) method are performed in part by a specialized device such as an adiabatic quantum computer or a quantum annealer or a system to program or otherwise control operation of an adiabatic quantum computer or a quantum annealer, for instance a computer that includes at least one digital processor. The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for exemplary purposes only and may change in alternative examples. Some of the exemplary acts or operations of the above described method(s), process(es), or technique(s) are performed iteratively. Some acts of the above described method(s), process(es), or technique(s) can be performed during each iteration, after a plurality of iterations, or at the end of all the iterations.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other methods of quantum computation, not necessarily the exemplary methods for quantum computation generally described above.

The various implementations described above can be combined to provide further implementations. All of the commonly assigned US patent application publications, US patent applications, foreign patents, and foreign patent applications referred to in this specification and/or listed in the Application Data Sheet are incorporated herein by reference, in their entirety, including but not limited to:
U.S. Pat. Nos. 7,533,068; 8,008,942; 8,195,596; 8,190,548; and 8,421,053.
U.S. Patent Application Publication No. 2014/0344322.
U.S. Provisional Patent Application No. 63/420,779.
International Application No. PCT/IB2022/000201.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method of operation of a computing system to direct a search space towards feasibility to improve performance of the computing system, the computing system comprising one or more processors, the method being performed by at least one of the one or more processors, the method comprising:
receiving a problem definition comprising a set of variables, an objective function defined over the set of variables, and one or more constraint functions, each of the constraint functions defined by at least one variable of the set of variables;
initializing an optimization algorithm, a sample solution to the objective function, and one or more penalty parameters corresponding to each of the constraint functions;
iteratively until a termination criteria is met:
incrementing the optimization algorithm;
for each variable in the set of variables:
sampling an updated value for the variable;
evaluating a feasibility result of each constraint function defined by the variable;
updating a problem feasibility result, the problem feasibility result comprising the feasibility result of each of the constraint functions; and
for each constraint function defined by the variable where the constraint function was not feasible, increasing the penalty parameter by a first rate;
after updating each variable in the set of variables, evaluating the problem feasibility result;
when the problem feasibility result indicates feasibility was encountered for all constraint functions, decreasing all penalty parameters by a second rate;
storing each updated penalty parameter;
evaluating the termination criteria; and
when the termination criteria is met, outputting a solution comprising an updated set of variables.

2. The method of claim 1, wherein incrementing the optimization algorithm comprises incrementing one of simulated annealing, parallel tempering, and quantum annealing.

3. The method of claim 1, wherein increasing the penalty parameter by a first rate comprises increasing the penalty parameter by a first rate that depends on the termination criteria and a number of variables that participate in the respective constraint function.

4. The method of claim 1, wherein decreasing all penalty parameters by a second rate comprises decreasing all penalty parameters by a second rate that depends on the termination criteria.

5. The method of claim 1, wherein evaluating the termination criteria comprises evaluating a number of iterations.

6. The method of claim 1, wherein outputting a solution comprising the updated set of variables comprises outputting a solution comprising a plurality of updated sets of variables, the method further comprising:
transmitting pairs of the sample solutions to a quantum processor;
instructing the quantum processor to refine the pairs of the sample solutions; and
returning refined sample solutions.

7. The method of claim 6, wherein instructing the quantum processor to refine the pairs of the sample solutions comprises instructing the quantum processor to perform quantum annealing to select a variable value for each variable from between respective variable values provided by the pairs of the sample solutions.

8. A system to direct a search space for an optimization problem towards feasibility to improve performance of a computing system, the system comprising:
at least one non-transitory processor-readable medium that stores at least one of processor executable instructions and data; and
at least one processor communicatively coupled to the least one non-transitory processor-readable medium, which, in response to execution of the at least one of processor executable instructions and data, the processor:
receives a problem definition comprising a set of variables, an objective function defined over the set of variables, and one or more constraint functions, each of the constraint functions defined by at least one variable of the set of variables;
initializes an optimization algorithm, a sample solution to the objective function, and one or more penalty parameters corresponding to each of the constraint functions; iteratively until a termination criteria is met:
increments the optimization algorithm;
for each variable in the set of variables:
samples an updated value for the variable;
evaluates a feasibility result of each constraint function defined by the variable;
updates a problem feasibility result, the problem feasibility result comprising the feasibility result of each of the constraint functions; and
for each constraint function defined by the variable where the constraint function was not feasible, increases the penalty parameter by a first rate;
after updating each variable in the set of variables, evaluates the problem feasibility result;
when the problem feasibility result indicates feasibility was encountered for all constraint functions, decreases all penalty parameters by a second rate;
stores each updated penalty parameter;
evaluates the termination criteria; and
when the termination criteria is met, outputs a solution comprising an updated set of variables.

9. The system of claim 8, wherein the processor increments the optimization algorithm comprising one of simulated annealing, parallel tempering, and quantum annealing.

10. The system of claim 8, wherein the first rate depends on the termination criteria and a number of variables that participate in the respective constraint function.

11. The system of claim 8, wherein the second rate depends on the termination criteria.

12. The system of claim 8, wherein the termination criteria comprises a number of iterations.

13. The system of claim 8, further comprising a quantum processor, and wherein in response to execution of the at least one of processor executable instructions and data, the processor outputs a solution comprising a plurality of updated sets of variables, and further:
transmit pairs of the sample solutions to the quantum processor;
instruct the quantum processor to refine the pairs of the sample solutions; and
return refined sample solutions.

14. The system of claim 13, wherein in response to execution of the at least one of processor executable instructions and data, the processor instructs the quantum processor to perform quantum annealing to select a variable value for each variable from between respective variable values provided by the pairs of the sample solutions.

15. A method of operation of a computing system to direct a search space for an optimization problem towards feasibility to improve performance of the computing system, the computing system comprising one or more processors, the method being performed by at least one of the one or more processors, the method comprising:
initializing an optimization algorithm;
iteratively until a termination criteria is met:
receiving a sample solution from the optimization algorithm;
evaluating quality and feasibility of the sample solution;
where the sample solution from the optimization is feasible and has a best quality so far, freezing one or more penalty parameters for a set number of iterations;
where the sample solution is not feasible or does not have the best quality so far, updating the one or more penalty parameters based on a finite state machine;
returning the updated one or more penalty parameters to the optimization algorithm;
incrementing the optimization algorithm; and
evaluating the termination criteria; and
in response to the termination criteria being met, returning one or more sample solutions to the optimization problem.

16. The method of claim 15, wherein updating the one or more penalty parameters based on a finite state machine comprises entering one of a growing state, an exploring state, and a frozen state and acting on the one or more penalty parameters based on the entered one of the growing state, the exploring state, or the frozen state.

17. The method of claim 16, wherein:
entering a growing state and acting on the one or more penalty parameters based on the growing state comprises increasing the one or more penalty parameters;
entering an exploring state and acting on the one or more penalty parameters based on the exploring state comprises performing a search for new values for the one or more penalty parameters; and
entering a frozen state and acting on the one or more penalty parameters based on the frozen state comprises maintaining current values for the one or more penalty parameters.

18. The method of claim 17, wherein entering a growing state and acting on the one or more penalty parameters based on the growing state by increasing the one or more penalty parameters comprises increasing the one or more penalty parameters based on a growth function.

19. The method of claim 18, wherein increasing the one or more penalty parameters based on a growth function comprises increasing the one or more penalty parameters based on a growth function that depends on the number of iterations performed.

20. The method of claim 15, wherein initializing an optimization algorithm comprises initializing one of simulated annealing, parallel tempering, and quantum annealing.
